(19) United States
(12) Patent Application Publication
(10) Pub. No.: US 2020/0151118 A1
(43) Pub. Date: May 14, 2020

(54) METHOD AND APPARATUS FOR OFFLOADING FILE I/O BASED ON REMOTE DIRECT MEMORY ACCESS USING UNIKERNEL

(71) Applicant: ELECTRONICS AND TELECOMMUNICATIONS RESEARCH INSTITUTE, Daejeon (KR)

(72) Inventors: Yeon-Jeong JEONG, Daejeon (KR); Jin-Mee KIM, Sejong (KR); Ramneek, Daejeon (KR); Seung-Hyub JEON, Anyang (KR); Sung-In JUNG, Daejeon (KR); Seung-Jun CHA, Daejeon (KR)

(21) Appl. No.: 16/582,597

(22) Filed: Sep. 25, 2019

(30) Foreign Application Priority Data
Nov. 12, 2018 (KR) 10-2018-0138453
Jul. 17, 2019 (KR) 10-2019-0086140

(51) Int. Cl. G06F 13/16; G06F 16/182; G06F 15/173; G06F 16/11

(52) U.S. Cl. CPC G06F 13/1668; G06F 16/122; G06F 15/17331; G06F 16/183

(57) ABSTRACT

Disclosed herein is an operating method of an apparatus for offloading file I/O of a unikernel based on Remote Direct Memory Access (RDMA). The operating method may include calling, by the application of the unikernel, a file I/O kernel function; generating, by the file I/O kernel function, file I/O information; transmitting, by the unikernel, the file I/O information to a Linux; configuring, by the Linux, a file I/O function using the file I/O information and calling the same; and transmitting, by the file I/O function, a file I/O request, corresponding to the file I/O information, to a file server.

### CROSS REFERENCE TO RELATED APPLICATIONS

This application claims the benefit of Korean Patent Application No. 10-2018-0138453, filed Nov. 12, 2018, and No. 10-2019-0086140, filed Jul. 17, 2019, which are hereby incorporated by reference in their entireties into this application.

### BACKGROUND OF THE INVENTION

### 1. Technical Field

The present invention relates to a method and apparatus for offloading file input/output (I/O) of a unikernel based on Remote Direct Memory Access (RDMA).

### 2. Description of the Related Art

Generally, a unikernel is an image that is executable without a separate operating system (OS). Such an image includes the code of an application and all OS functions required to run the application. That is, a unikernel combines the code of an application with the smallest subset of OS components required to run the application, thereby realizing a fast boot time, a small size, and small attack surfaces. Also, the unikernel may be started and terminated more quickly and securely because it is smaller than an existing OS. The unikernel employs an offloading method in order to process file I/O because it does not include a large-size module, such as a file system, in its libraries. However, the use of such an offloading method may impede fast processing, which is an advantage of the unikernel, because file I/O offloaded from the unikernel is performed in such a way that a file I/O command is sent to the proxy of a host server and the result of the file I/O performed by the proxy is copied to the unikernel and is then used.

### SUMMARY OF THE INVENTION

An object of the present invention is to provide a method and apparatus for offloading file I/O, which enable high-speed file I/O in a unikernel.

Another object of the present invention is to provide a method and apparatus for offloading file I/O, in which, in order to support file I/O in a unikernel application, the file I/O is offloaded to Linux, whereby data stored in a nonvolatile memory express (NVMe) device of a file server may be quickly transmitted to the buffer of the unikernel application through Remote Direct Memory Access (RDMA).

The technical objects of the present invention are not limited to the above technical objects, and other technical objects that are not mentioned will be readily understood by a person of ordinary skill in the art from the following description.

An operating method of an apparatus for offloading file I/O of a unikernel based on RDMA according to an embodiment of the present invention may include calling, by an application of the unikernel, a file I/O kernel function; generating, by the file I/O kernel function, file I/O information; transmitting, by the unikernel, the file I/O information to a Linux; configuring and calling, by the Linux, a file I/O function using the received file I/O information; and transmitting, by the file I/O function, a file I/O request, corresponding to the file I/O information, to a file server.

In an embodiment, the generating the file I/O information may include extracting information about consecutive physical address spaces of a file I/O buffer; and generating an I/O vector corresponding to the extracted information.

In an embodiment, the operating method may further include running a file I/O proxy of the Linux.

In an embodiment, the operating method may further include the receiving, by the file I/O proxy, the file I/O information from the unikernel.

In an embodiment, the file I/O information may include a file I/O command, a file descriptor, an I/O vector, and a vector count.

In an embodiment, transmitting the file I/O request to the file server may include transmitting, by a file-system stub of the Linux, the file I/O request corresponding to the number of I/O vectors to the file server.

In an embodiment, the operating method may further include receiving, by the Linux, a result of processing the file I/O request from the file server.

In an embodiment, the operating method may further include transmitting, by the Linux, the result of processing the file I/O request to the unikernel when the result is success.

In an embodiment, the operating method may further include writing data in the file server to memory of the unikernel based on RDMA in response to the file I/O request.

An operating method of an apparatus for offloading file I/O of a unikernel based on RDMA according to an embodiment of the present invention may include receiving, by a file server, a file I/O request from a Linux of a unikernel system; extracting, by the file server, file information corresponding to the file I/O request from a file system; inputting/outputting data in a nonvolatile memory using the file information; and transmitting the data to the unikernel system using an RDMA engine.

In an embodiment, the operating method may further include transmitting, by the file server, a result of file I/O performed in response to the file I/O request to the Linux of the unikernel system.

In an embodiment, the extracting the file information from the file system may include extracting the file information, which is necessary in order to execute a file I/O command for a file identified by a file descriptor included in the file I/O request.

In an embodiment, the operating method may further include dictating, by the file server, that the data input to or output from the nonvolatile memory be copied to an RDMA Network Interface Card (NIC).

In an embodiment, the RDMA engine may transmit the data to a physical memory of a unikernel of the unikernel system through RDMA.

An apparatus for offloading file I/O based on RDMA according to an embodiment of the present invention may include at least one processor; and memory for storing a unikernel and a Linux run by the at least one processor. The unikernel may be configured such that an application calls a file I/O kernel function, such that the file I/O kernel function generates file I/O information, and such that the file I/O information is transmitted to the Linux, and the Linux may be configured such that a file I/O function is configured using the file I/O information and is called and such that a file I/O request corresponding to the file I/O information is transmitted from the file I/O function to a file server.

In an embodiment, the Linux may run a file I/O proxy, thereby receiving the file I/O information from the unikernel.

In an embodiment, the Linux may transmit an I/O command to the file server in order to read data having a size corresponding to an I/O vector size from a file identified by a file descriptor and to write the data to a physical address specified in an I/O vector using the file I/O information.

In an embodiment, the Linux may receive a result of executing the I/O command from the file server.

In an embodiment, the apparatus may further include an RDMA Network Interface Card (NIC) configured to input or output data to or from the file server based on RDMA in response to the I/O command.

In an embodiment, the Linux may be used as a device driver for a storage device of the file server.

A method and apparatus for offloading file I/O according to an embodiment of the present invention may offload file I/O generated in a unikernel to Linux in order to perform high-speed I/O in the unikernel, and the offloaded file I/O may be processed in such a way that the data of a file stored in an NVMe device may be transmitted to the memory of the unikernel based on RDMA through Linux and a file server.

A method and apparatus for offloading file I/O according to an embodiment of the present invention may be implemented so as to offload I/O from a unikernel to Linux in order to access NVMe device data storage over a network through RDMA.

A method and apparatus for offloading file I/O according to an embodiment of the present invention enable a user to remotely access a device over a network and to perform all disk operations as if the user accessed a local machine.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that illustrates an apparatus for offloading file I/O according to an embodiment of the present invention;

FIG. 2 is a ladder diagram that illustrates the process in which an apparatus for offloading file I/O according to an embodiment of the present invention offloads file I/O from a unikernel to Linux and a file server;

FIG. 3 is a view that illustrates the process of transmitting file I/O information from a unikernel to Linux in a unikernel system according to an embodiment of the present invention;

FIG. 4 is a view that illustrates the process of offloading file I/O in order to perform a read operation in the application of a unikernel according to an embodiment of the present invention;

FIG. 5 is a flowchart that illustrates the process of offloading file I/O from the application of a unikernel to Linux and performing the file I/O using a file server according to an embodiment of the present invention;

FIG. 6 is a view that specifically illustrates an apparatus for offloading file I/O from a unikernel to Linux and a file server according to an embodiment of the present invention; and

FIG. 7 is a view that illustrates an electronic device according to an embodiment of the present invention.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that those embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms. These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, terms used herein are used merely to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Generally, OSs have their own methods for defining mapping between virtual addresses and physical addresses. Therefore, even when the virtual addresses allocated to the buffer of a unikernel application are given, Linux may not access the physical memory allocated to the buffer. Also, even when Linux is aware of the physical address mapped to the virtual address of the start location of the buffer in the unikernel, unless the physical addresses mapped to the virtual addresses of the buffer are consecutive, the physical address pointing to any one location of the buffer may not be obtained. That is, because a buffer generally includes discontinuous physical pages, it is not guaranteed that the physical address of any location of the buffer will be obtained using only the consecutive virtual addresses allocated to the buffer. Accordingly, a conventional unikernel receives a copy of a file I/O result from a host OS or a file server and uses the same in order to perform file I/O.

In order to perform file I/O, the memory address to which data is input or from which data is output is required.

To this end, the present invention may transmit a set of elements, each of which comprises the start address of consecutive physical pages and the size thereof, among the physical pages mapped to the virtual addresses of an I/O buffer in a unikernel, and the number of elements in the set to Linux. That is, when a file I/O command is transmitted from the unikernel to Linux, an I/O vector, including the physical address of data in the unikernel and the size thereof, may also be transmitted. This is because the unikernel and Linux use different virtual addresses for the same physical address. That is, Linux is not able to extract the physical address of memory using the virtual address used in the unikernel, and vice-versa.

Also, because the physical address of memory is used, rather than the virtual address, data may be input and output based on RDMA or DMA. That is, Linux may transmit a specified amount of data from a Non-Volatile Memory Express (NVMe) device in a file server to the unikernel I/O buffer pointed to by the physical address based on RDMA, whereby high-speed I/O may be realized.

Also, in order to improve the performance of an application that requires file I/O in the operating environment of a unikernel, a high-speed file I/O function is required. In the present invention, a Linux may be installed in some system resources (e.g., memory), file I/O may be offloaded to the installed Linux, and data may be read from or written to the NVMe device in a file server based on RDMA, whereby high-speed file I/O may be performed.

For example, the present invention may be configured to install a Linux in some resources of a system and to use the same as a device driver in order to perform file I/O in the unikernel. Here, the unikernel may transmit a file I/O command to the installed Linux in order to offload file I/O. Then, the Linux may request a file server to perform the file I/O, that is, to read or write data from or to the memory pointed to by the physical address in the unikernel, the physical address being included in the file I/O command. The file server extracts information required for accessing a file stored in the NVMe device from a file system, performs I/O by accessing the data in the NVMe device, and quickly transmits the data to the memory pointed to by the physical address in the unikernel through RDMA.

In the present invention, there is no need to construct an additional file system software stack for high-speed file I/O in the unikernel, and intervention by the kernel may be minimized when file I/O is performed.

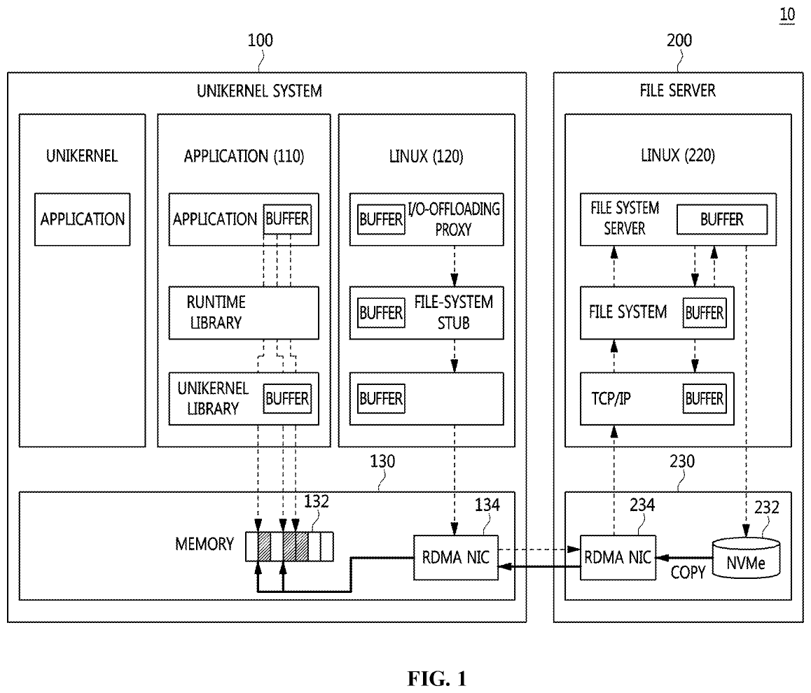

FIG. 1 is a view that illustrates an apparatus 10 for offloading file I/O according to an embodiment of the present invention. Referring to FIG. 1, the apparatus 10 for offloading file I/O may include a unikernel system 100 and a file server 200.

The unikernel system 100 may include a unikernel 110, a Linux 120, and shared memory 130.

The unikernel 110 is an image occupying a single address space, implemented as a library OS. That is, an application includes OS functions required to run the application in the form of libraries, and the image itself acts as a dedicated kernel for the application. The unikernel 110 has a software stack in which a single address space is used, rather than differentiating between a user space and a kernel space. Using such a single address space, the unikernel 110 eliminates transition between a kernel mode and a user mode and minimizes the number of copies of data, thereby maximizing the performance of the application. For example, the unikernel 110 may be MirageOS, a rump kernel for software compatible with POSIX, IncludeOS for support of C++ applications, HermitCore for High Performance Computing (HPC), or the like.

The Linux (a ‘first Linux’) 120 is a monolithic kernel, and may perform I/O operations in conjunction with the file server 200.

The shared memory 130 may include unikernel memory 132 and a Remote Direct Memory Access Network Interface Card (RDMA NIC) 134.

The file server 200 may include a Linux (a ‘second Linux’) 220 and memory 230. Here, the memory 230 may include nonvolatile memory (NVMe device) 232 and an RDMA NIC 234. Meanwhile, the nonvolatile memory may be implemented as any of various types of nonvolatile memory, other than an NVMe device.

The apparatus 10 for offloading file I/O according to an embodiment of the present invention may perform high-speed file I/O in the unikernel 110.

The apparatus 10 for offloading file I/O may offload I/O from the unikernel 110 to the first Linux 120 in order to perform high-speed I/O in the unikernel 110. Here, the offloaded file I/O may be processed in such a way that the data of a file stored in the NVMe device 232 is written to the memory 132 of the unikernel 110 based on RDMA through the first Linux 120 and the file server 200. In an embodiment, in order to access the NVMe device 232 over a network via RDMA NICs 134 and 234 in the I/O process in the unikernel, the I/O of the unikernel 110 may be offloaded to the Linux 120. In an embodiment, the unikernel 110 enables a user to remotely access the NVMe device 232 over a network and to perform all disk operations (read, write, and the like) as if the user accessed a local machine.

That is, the apparatus 10 for offloading file I/O according to an embodiment of the present invention offloads I/O generated in the unikernel 110 to the Linux 120 in the unikernel system 100 in order to perform high-speed I/O in the unikernel 110, and the offloaded file I/O may be processed in such a way that the data of a file stored in the NVMe device 232 is written to the unikernel memory 132 based on RDMA through the Linux 120 and the file server 200.

The apparatus 10 for offloading file I/O according to an embodiment of the present invention enables the application of the unikernel 110 to offload file I/O to the Linux 120 and the file server 120, and performs high-speed file I/O based on RDMA.

The apparatus 10 for offloading file I/O according to an embodiment of the present invention may offload file I/O from a unikernel to a Linux using the software stack (a file system, a network file system, or the like) of a general-purpose OS, which is difficult to construct in the unikernel environment, and may perform high-speed file I/O based on RDMA.

The apparatus 10 for offloading file I/O according to an embodiment of the present invention offloads I/O to a general-purpose OS in order to perform high-speed file I/O in the unikernel 110, whereby there is no need to configure a heavy software stack, such as a file system, in the unikernel 110.

The apparatus 10 for offloading file I/O according to an embodiment of the present invention may configure a kernel library such that, even if multiple unikernel applications are run in a single system, each unikernel is implemented as a lightweight kernel so as to run optimally without the need to construct a file system in each unikernel.

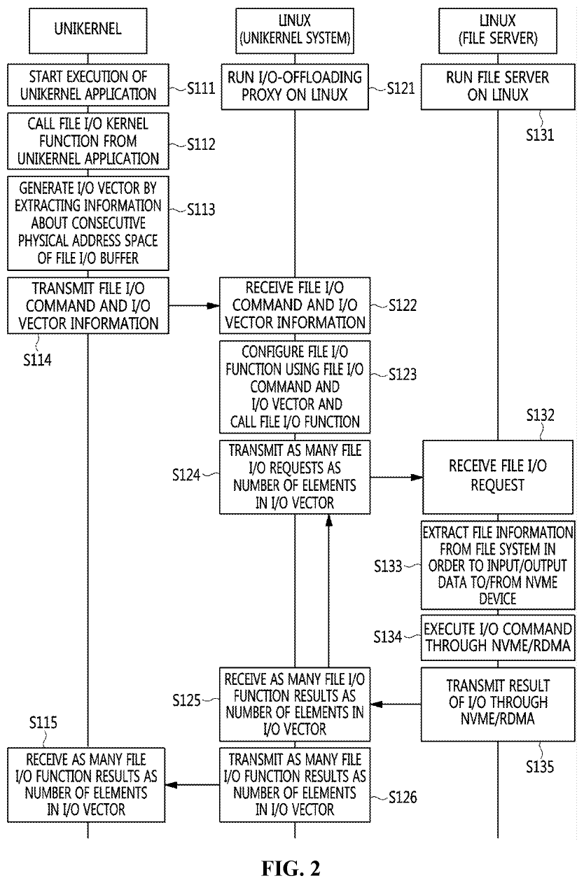

FIG. 2 is a ladder diagram that illustrates a process in which an apparatus 10 for offloading file I/O according to an embodiment of the present invention offloads file I/O from a unikernel to a Linux and a file server 200. Referring to FIG. 2, the process of offloading file I/O may be performed as follows.

The unikernel 110 may operate as follows. The unikernel 110 may start running an application at step S111. The unikernel application may call a file I/O function at step S112. The unikernel 110 may extract information about a consecutive physical address space pertaining to a file I/O buffer and generate file I/O information (e.g., a file I/O command and an I/O vector) at step S113. After execution of the application of the unikernel is started, when the file I/O function is called during the execution of the application, the unikernel 110 may generate file I/O information, including the file I/O command of the unikernel, a file descriptor, an I/O vector, and a vector count, in order to offload the file I/O to the Linux 120. The file I/O command is an I/O command, such as read, write or the like. The file descriptor is a value representing a file allocated by the system. The I/O vector is a set of elements, each of which comprises the start address of consecutive physical pages and the size thereof, among the physical pages mapped to the virtual addresses of the I/O buffer. The vector count is the number of elements in the I/O vector.

The unikernel 110 may transmit the file I/O information (the file I/O command and the I/O vector) to the Linux 120 at step S114. Here, the reason why the file I/O information, transmitted from the unikernel 110 to the Linux 120, includes the I/O vector including the physical address of the buffer of the unikernel and the size thereof is that the unikernel 110 and the Linux 120 use different virtual addresses for the same physical address and that they are not able to extract the physical address of memory using the virtual address used in the other kernel. Also, because the physical address of memory is used, rather than the virtual address used in an individual OS, data is input or output based on RDMA or DMA. The file I/O information of the unikernel, generated as described above, may be transmitted to the I/O-offloading proxy of the Linux 120. Then, the unikernel 110 may receive as many file I/O function results as the number of elements in the I/O vector from the Linux 120 at step S115.

The Linux 120 may operate as follows. The Linux 120 may run a file-I/O-offloading proxy at step S121. The Linux 120 may receive the file I/O information (the file I/O command and the I/O vector) from the unikernel 110 at step S122. The Linux 120 may configure a file I/O function using the file I/O information (the file I/O command and the I/O vector) and call the same at step S123. Here, the file-I/O-offloading proxy of the Linux 120 may configure the file I/O function to be transmitted to a file-system stub using the received file I/O information. When the Linux 120 executes the corresponding file I/O function, a file I/O command may be transmitted to the file server 200 through the file-system stub of the Linux. The Linux 120 may transmit the I/O command to the file server 200 in order to input or output data having a size corresponding to the I/O size specified in the I/O vector between the file identified by the file descriptor and the buffer pointed to by the physical address specified in the I/O vector at step S124. Here, the file-system stub may request the file server to perform file I/O for each element of the I/O vector as many times as the number of elements in the I/O vector. That is, the file I/O may be performed on the basis of consecutive physical addresses. Here, the file I/O information to be transmitted to the file server includes the file I/O command, the file descriptor, the physical address specified in the I/O vector, and the I/O size specified in the I/O vector.

Then, the Linux 120 may receive a number of results of the file I/O function equal to the number of elements in the I/O vector from the NVMe device 232 and the RDMA NIC 234 of the file server 200 at step S125. Then, the Linux 120 may transmit a number of results of the file I/O function equal to the number of elements in the I/O vector to the unikernel memory 132 of the unikernel 110.

The file server 200 may operate as follows. The file server 200 may run a file server daemon on the Linux 220 at step S131. The Linux 220 of the file server 200 may receive a file I/O request from the Linux 120 of the unikernel system 100 at step S132. The Linux 220 of the file server 200 may extract file information from the file system at step S133 in order to perform the I/O command for the NVMe file identified by the file descriptor. When it receives the file I/O request from the Linux 120 of the unikernel system 100, the file server 200 may extract information required for performing I/O in the NVMe device from the file system in order to execute the I/O command for the file identified by the file descriptor. The file server 200 may read data having a size corresponding to the I/O size from the NVMe device, transmit the data through RDMA, and transmit the data to the specified physical address using an RDMA engine. The Linux 220 of the file server 200 may execute the I/O command in the NVMe device and the RDMA NIC at step S134. The Linux 220 of the file server 200 may transmit the data having the corresponding size to the physical address and transmit the file I/O result to the Linux 120 of the unikernel system 100 at step S135.

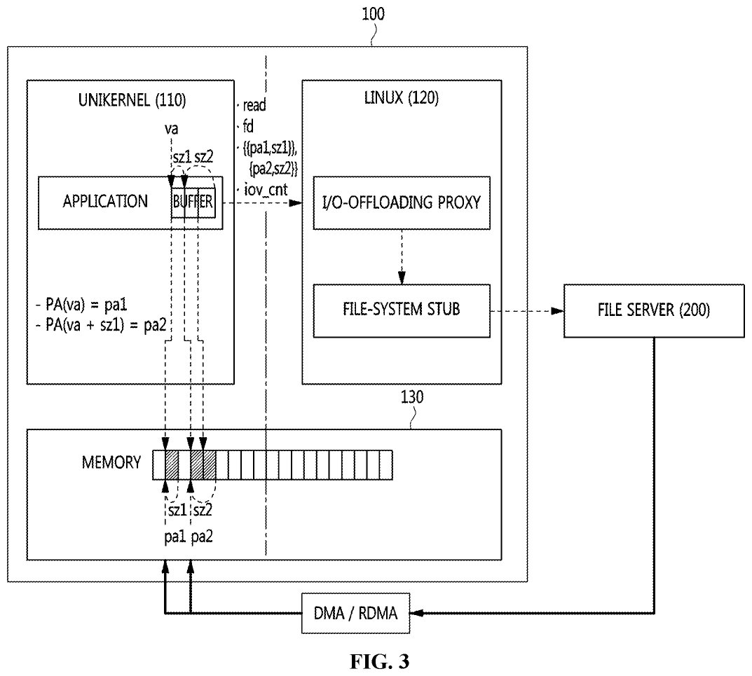

FIG. 3 is a view that illustrates the process of transmitting file I/O information from the unikernel 110 to the Linux 120 in the unikernel system 100 according to an embodiment of the present invention. Referring to FIG. 3, the process of transmitting file I/O information from the unikernel 110 to the Linux 120 in the unikernel system 100 may be performed as follows.

The unikernel 110 may transmit the I/O command of the unikernel 110, a file descriptor, an I/O vector, and a vector count to the I/O-offloading proxy of the Linux as the file I/O information for offloading file I/O to the Linux 120. Here, the I/O command is an I/O command such as read, write or the like. The file descriptor is a value that represents a file allocated by the system. The I/O vector is a set of elements, each of which comprises the start address of consecutive physical pages and the size thereof, among the physical pages mapped to the virtual addresses of an I/O buffer. The vector count is the number of elements in the I/O vector.

In FIG. 3, the file command is ‘read’, and the file descriptor is denoted by ‘fd’. When the virtual address of the I/O buffer is va and when the size thereof is sz, the I/O vector may include the start address of consecutive physical pages having a size of sz1 and the start address of consecutive physical pages having a size of sz2 (where sz=sz1+sz2). That is, the I/O vector may be represented as {{pa1, sz1}, {pa2, sz2}}. Here, the vector count is the number of elements in the I/O vector, that is, iov_cnt=2. That is, when the buffer of the unikernel memory 130 includes three pages and when, among the three physical pages mapped thereto, two physical pages are consecutive, the number of elements in the I/O vector is two.

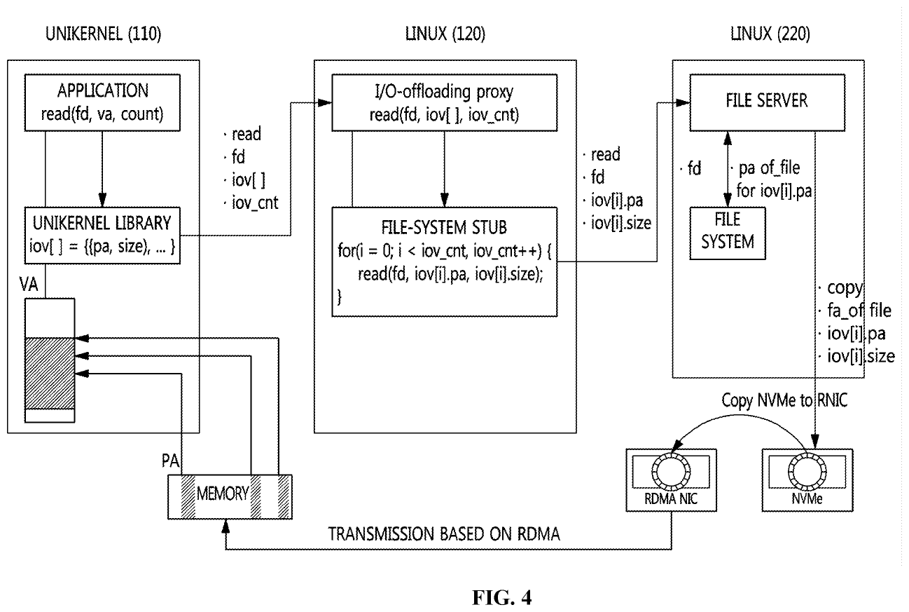

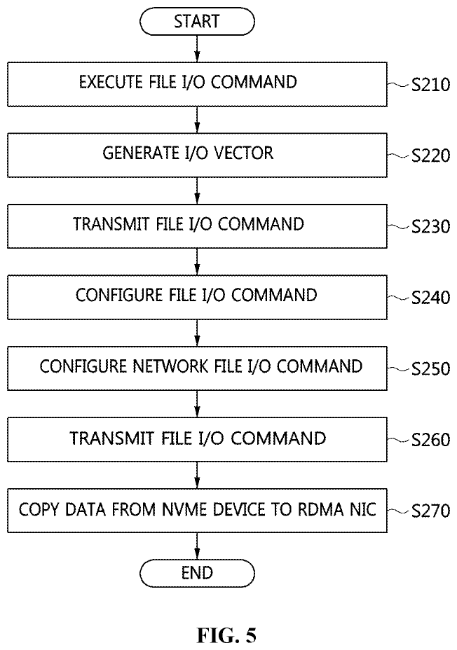

FIG. 4 is a view that illustrates the process of offloading file I/O in order to perform a read operation in the application of the unikernel 110 according to an embodiment of the present invention. FIG. 5 is a flowchart that illustrates a process in which the application of the unikernel 110 offloads file I/O to the Linux 120 and in which a file is input to or output from a file server according to an embodiment of the present invention. Referring to FIG. 4 and FIG. 5, the application of the unikernel 110 may perform a file-I/O-offloading operation for the read operation as follows.

The application of the unikernel 110 may execute an I/O function (e.g., read (fd, va, count)) at step S210. The unikernel 110 may form an I/O vector (=iov[ ]), which is a set of elements, each of which comprises the start address pa of consecutive physical pages and the size thereof, among the physical pages of the I/O buffer starting from the virtual address va and having a size corresponding to ‘count’, at step S220. The I/O vector count denoted by iov_cnt is the number of elements in the I/O vector. The unikernel 110 may send a file I/O information message including parameters related to the file I/O (e.g., read, fd, iov[ ], and iov_cnt) to the Linux 120 at step S230.

The I/O-offloading proxy in a standby state in the Linux 120 may receive the file I/O information message, configure a file I/O function (e.g., read (fd, iov[ ], iov_cnt)), and execute the same at step S240.

The file-system stub of the Linux 120 may configure a function for performing the i-th file I/O (e.g., write_io (fd, iov[i], pa, iov[i].iov_cnt) where 0<=i<iov_cnt) at step S250 in order to request the file server 220 to execute the same. The file-system stub of the Linux 120 may transmit the i-th file I/O message (e.g., read, fd, iov[i], pa, iov[i].iov_cnt) to the file server 200 at step S260.

The Linux 220 of the file server 200 may extract, from the file system, information that is necessary in order to execute the file I/O command for the file identified by the received file descriptor. For example, information required for reading from the file stored in the NVMe device 232 may be extracted using the file descriptor fd. The file server 200 may dictate that the data of the file stored in the NVMe device 232 be copied to the RDMA NIC 234. Accordingly, the data may be copied from the NVMe device 232 to the RDMA NIC 234 at step S270. The RDMA engine may transmit the data to the physical memory (e.g., iov[i].pa) of the unikernel 110 through RDMA.

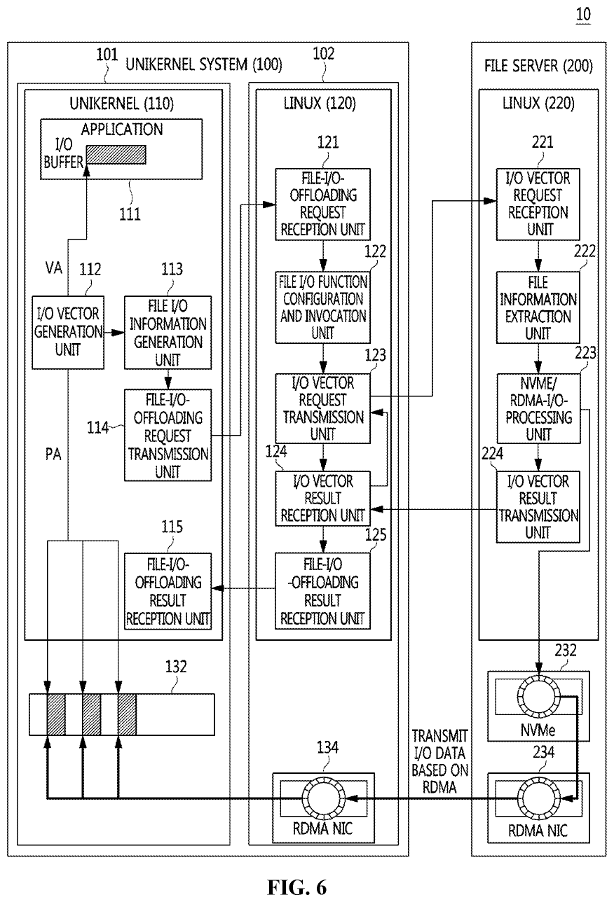

FIG. 6 is a view that specifically shows the apparatus 10 for offloading file I/O from a unikernel to Linux and a file server according to an embodiment of the present invention. Referring to FIG. 6, the apparatus 10 for offloading file I/O may include a unikernel system 100 and a file server 200.

The unikernel system 100 may include a first kernel system 101 and a second kernel system 102.

The first kernel system 101 may include a unikernel 110 and unikernel memory 132. The unikernel 110 may include an application 111, an I/O vector generation unit 112, a file I/O information generation unit 113, a file-I/O-offloading request transmission unit 114, and a file-I/O-offloading result reception unit 115.

Because the application of the unikernel 110 includes the code of the application and all OS functions required to run the application, the application may be run without any specific OS. The I/O vector generation unit 112 may generate an I/O vector, which is a set of elements, each of which comprises the start address of consecutive physical pages and the size thereof, among the physical pages mapped to the virtual addresses va of the I/O buffer.

The file I/O information generation unit 113 may generate file I/O information that is necessary in order to offload file I/O to the Linux. Here, the file I/O information may include the I/O command of the unikernel, a file descriptor, the I/O vector, the vector count, and the like.

The file-I/O-offloading request transmission unit 114 may transmit the file I/O information to the Linux 120.

The file-I/O-offloading result reception unit 115 may receive a file-I/O-offloading result from the file-I/O-offloading result transmission unit 125 of the Linux 120.

The second kernel system 102 may include a Linux 120 and an RDMA NIC 134. The Linux 120 may include a file-I/O-offloading request reception unit 121, a file I/O function configuration and invocation unit 122, an I/O vector request transmission unit 123, an I/O vector result reception unit 124, and a file-I/O-offloading result transmission unit 125.

The file-I/O-offloading request reception unit 121 may receive file I/O information from the unikernel 110.

The file I/O function configuration and invocation unit 122 may configure a file I/O function using the received file I/O information and perform file I/O.

The I/O vector request transmission unit 123 may transmit a request for I/O for one element in the I/O vector to the file server 200. Here, a request for I/O for each element may be transmitted to the file server 200 as many times as the number of elements in the I/O vector.

The I/O vector result reception unit 124 may receive the result of the I/O, which is performed in response to the request for the I/O for the element of the I/O vector, from the file server 200. That is, the I/O vector result reception unit 124 may receive the result of the file I/O performed for one element of the I/O vector through the NVMe device and the RDMA NIC. In an embodiment, when the file I/O performed for one element of the I/O vector succeeds, the control branches to the I/O vector request transmission unit 123 in order to perform I/O for the next element in the I/O vector. Conversely, when the file I/O performed for one element of the I/O vector fails, the control branches to the file-I/O-offloading result transmission unit 125.

The file-I/O-offloading result transmission unit 125 may transmit the result of offloading the file I/O, corresponding to the result of the I/O performed for the elements of the I/O vector, to the file-I/O-offloading result reception unit 115 of the unikernel 110.

The file server 200 may include a Linux 220, an NVMe device 232, and an RDMA NIC 234. The Linux 220 may include an I/O vector request reception unit 221, a file information extraction unit 222, an NVMe/RDMA-I/O-processing unit 223, and an I/O vector result transmission unit 224.

The I/O vector request reception unit 221 may receive a request for the I/O of one element in the I/O vector from the Linux 120 of the unikernel system 100.

The file information extraction unit 222 may extract information required for executing a file I/O command for the file, identified by the received file descriptor, from the file system.

The NVMe/RDMA-I/O-processing unit 223 may copy file data stored in the NVMe device 232 to the RDMA NIC 234 and transmit the copied file data from the RDMA NIC 234 to the physical memory of the unikernel 110 via the RDMA NIC 134 of the Linux 120 of the unikernel system 100.

The I/O vector result transmission unit 224 may transmit the result of the file I/O, performed for one element of the I/O vector through the NVMe device and the RDMA NIC, to the Linux 120 of the unikernel system 100.

The apparatus 10 for offloading file I/O according to an embodiment of the present invention may offload the file I/O of the application of the unikernel 110 to the Linux 120 and the file server 200, thereby performing high-speed file I/O based on RDMA.

The apparatus 10 for offloading file I/O according to an embodiment of the present invention uses the software stack (a file system or a network file system) of a general-purpose OS when it constructs a file I/O environment in the unikernel 110, thereby offloading file I/O from the unikernel to Linux, consequently performing high-speed file I/O through RDMA.

The apparatus 10 for offloading file I/O according to an embodiment of the present invention offloads I/O to a general-purpose OS in order to perform high-speed file I/O in the unikernel 110, whereby there is no need to configure a heavy software stack, such as a file system, in the unikernel 110.

The apparatus 10 for offloading file I/O according to an embodiment of the present invention may configure a kernel library such that, even if multiple unikernel applications are run in a single system, each unikernel may be implemented as a lightweight kernel so as to run optimally without the need to construct a file system in each unikernel.

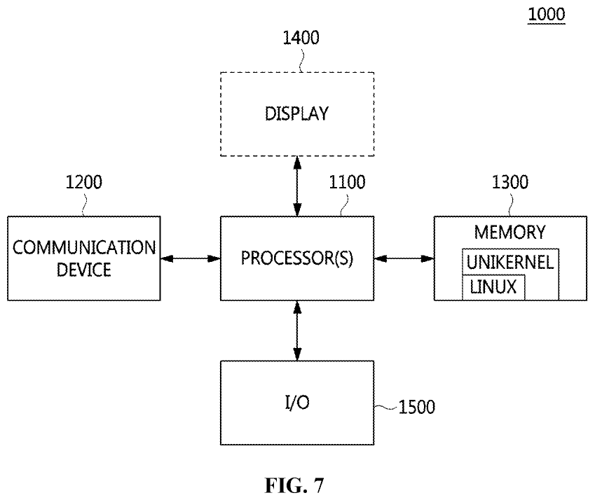

FIG. 7 is a view that illustrates an electronic device 1000 according to an embodiment of the present invention. Referring to FIG. 7, the electronic device 1000 may include at least one processor 1100, a network interface 1200, memory 1300, a display 1400, and an I/O device 1500. The electronic device 1000 illustrated in FIG. 7 may include the above-described unikernel system 100.

The processor 1100 may include at least one of the devices described with reference to FIGS. 1 to 6, or may be implemented using at least one of the methods described with reference to FIGS. 1 to 6. The processor 1100 may execute instructions such that: execution of the application of the unikernel is started; the application of the unikernel calls a file I/O kernel function; file I/O information is generated in the unikernel; the file I/O information is transmitted from the unikernel to a Linux; a file I/O proxy is run in the Linux; the Linux receives the file I/O information from the unikernel; the Linux configures a file I/O function using the file I/O information and calls the same; the Linux requests a file server to execute an I/O command in order to read data having a size corresponding to the size specified in the I/O vector from the file identified by a file descriptor and to write the data to the physical address specified in the I/O vector; the Linux performs I/O as many times as the number of elements in the I/O vector included in the file I/O information and transmits the result thereof to the unikernel; and the unikernel receives the file I/O result from the Linux, as described above.

The processor 1100 may run programs and control the electronic device 1000. The electronic device 1000 may be connected with an external device (e.g., a personal computer or a network) and may exchange data therewith via the I/O devices 1500.

The network interface 1200 may be implemented so as to communicate with an external network using any of various wired/wireless methods.

The memory 1300 may store computer-readable instructions. The processor 1100 may perform the above-described operations by executing the instructions stored in the memory 1300. The memory 1300 may be volatile or nonvolatile memory. The memory 1300 may include a storage device in order to store user data. The storage device may be an embedded multimedia card (eMMC), a solid-state drive (SSD), universal flash storage (UFS), or the like. The storage device may include at least one nonvolatile memory device. The nonvolatile memory device may be any one of NAND flash memory, Vertical NAND (VNAND), NOR flash memory, Resistive Random-Access Memory (RRAM), Phase-Change Memory (PRAM), Magnetoresistive Random-Access Memory (MRAM), Ferroelectric Random-Access Memory (FRAM), Spin-Transfer-Torque Random-Access Memory (STT-RAM), and the like.

The embodiments described above may be implemented through hardware components, software components, and/or a combination thereof. For example, the apparatus, method and components described in the embodiments may be implemented using one or more general-purpose computers or special-purpose computers, for example, a processor, a controller, an arithmetic logic unit (ALU), a digital signal processor, a microcomputer, a field-programmable gate array (FPGA), a programmable logic unit (PLU), a microprocessor, or any other device capable of executing instructions and responding thereto. The processing device may run an operating system (OS) and one or more software applications executed on the OS.

Also, the processing device may access, store, manipulate, process and create data in response to execution of the software. For the convenience of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner. The software and data may be stored in one or more computer-readable storage media.

The method according to the embodiments may be implemented as program instructions executable by various computer devices, and may be recorded in computer-readable storage media. The computer-readable storage media may individually or collectively include program instructions, data files, data structures, and the like. The program instructions recorded in the media may be specially designed and configured for the embodiment, or may be readily available and well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter or the like. The above-mentioned hardware device may be configured so as to operate as one or more software modules in order to perform the operations of the embodiment, and vice-versa.

In the process of offloading a file I/O command of a unikernel to Linux and a file server, after the application of the unikernel is run, when a file I/O function is called during the execution of the application, the unikernel generates file I/O information, including the file I/O command of the unikernel, a file descriptor, an I/O vector, a vector count, and the like, in order to offload the file I/O to Linux. Here, the reason why the I/O vector, including the physical address of the buffer of the unikernel and the size thereof, is generated and included in the file I/O information is that the unikernel and Linux use different virtual addresses for the same physical address, so Linux is not able to extract the physical address of a memory location using the virtual address used in the unikernel, and vice versa. Also, in order to perform file I/O between a file server and the unikernel based on RDMA or DMA, the physical address of memory is required, rather than the virtual address used in an OS.

Therefore, the present invention configures an I/O vector, which is a set of elements, each of which comprises the start address of consecutive physical pages and the size thereof, among the physical pages mapped to the virtual addresses of the I/O buffer, and transmits the same along with a vector count, which is the number of elements in the I/O vector, to Linux as the file I/O information, whereby Linux requests the file server to perform file I/O for each element of the I/O vector. Accordingly, data having a size corresponding to the size of consecutive physical pages starting from the physical address may be quickly input or output based on RDMA.

The present invention uses the software stack (a file system or a network file system) of a general-purpose OS, which is difficult to construct in a unikernel. Accordingly, using some resources in the system, the unikernel may use Linux as if it were a device driver.

The present invention may perform high-speed file I/O through NVMe and RDMA when file I/O is offloaded from a unikernel to Linux. The present invention may be applied to data-centric computing, such as image processing, graphics processing, and deep learning, by using the present invention as the I/O method of a data-centric High-Performance Computing (HPC) kernel. The present invention may be used as the I/O method of an in-memory DB, in which a large amount of data must be quickly processed based on frequently accessed data, and of an NIC that supports 100 Gb/s.

Meanwhile, the present invention is not limited to offloading file I/O from a unikernel to Linux. It should be understood that the present invention may be used for offloading file I/O from a unikernel to any monolithic kernel OS (e.g., a UNIX kernel, a Solaris kernel, a Windows NT kernel, a Bellona2 kernel, an AIX kernel, or the like).

The method and apparatus for offloading file I/O according to an embodiment of the present invention enable the application of a unikernel to offload file I/O to Linux and a file server, thereby performing high-speed file I/O based on RDMA.

The method and apparatus for offloading file I/O according to an embodiment of the present invention use the software stack (e.g., a file system, a network file system, or the like) of a general-purpose OS, which is difficult to construct in a unikernel environment, whereby file I/O may be offloaded from a unikernel to Linux and high-speed file I/O may be provided through RDMA.

The method and apparatus for offloading file I/O according to an embodiment of the present invention offload file I/O to a general-purpose OS in order to perform high-speed file I/O in a unikernel. Accordingly, there is no need to configure a heavy software stack, such as a file system, in the unikernel.

The method and apparatus for offloading file I/O according to an embodiment of the present invention may configure a kernel library such that, even if multiple unikernel applications are run in a single system, each unikernel is implemented as a lightweight unikernel so as to run optimally without the need to construct a file system in each unikernel.

Meanwhile, the above description is merely specific embodiments for practicing the present invention. The present invention encompasses not only concrete and available means but also the technical spirit corresponding to abstract and conceptual ideas that may be used as future technology.

What is claimed is:

1. An operating method of an apparatus for offloading file input/output (I/O) of a unikernel based on Remote Direct Memory Access (RDMA), comprising:
calling, by an application of the unikernel, a file I/O kernel function;
generating, by the file I/O kernel function, file I/O information;
transmitting, by the unikernel, the file I/O information to a Linux;
configuring and calling, by the Linux, a file I/O function using the received file I/O information; and
transmitting, by the file I/O function, a file I/O request, corresponding to the file I/O information, to a file server.

2. The operating method of claim 1, wherein the generating the file I/O information comprises:
extracting information about consecutive physical address spaces of a file I/O buffer; and
generating an I/O vector corresponding to the extracted information.

3. The operating method of claim 1, further comprising:
running a file I/O proxy of the Linux.

4. The operating method of claim 3, further comprising:
receiving, by the file I/O proxy, the file I/O information from the unikernel.

5. The operating method of claim 1, wherein the file I/O information includes a file I/O command, a file descriptor, an I/O vector, and a vector count.

6. The operating method of claim 5, wherein the transmitting the file I/O request to the file server comprises:
transmitting, by a file-system stub of the Linux, the file I/O request corresponding to a number of I/O vectors to the file server.

7. The operating method of claim 1, further comprising:
receiving, by the Linux, a result of processing the file I/O request from the file server.

8. The operating method of claim 7, further comprising:
transmitting, by the Linux, the result of processing the file I/O request to the unikernel when the result is success.

9. The operating method of claim 1, further comprising:
writing data in the file server to memory of the unikernel based on RDMA in response to the file I/O request.

10. An operating method of an apparatus for offloading file input/output (I/O) of a unikernel based on Remote Direct Memory Access (RDMA), comprising:
receiving, by a file server, a file I/O request from a Linux of a unikernel system;
extracting, by the file server, file information corresponding to the file I/O request from a file system;
inputting/outputting data in a nonvolatile memory using the file information; and
transmitting the data to the unikernel system using an RDMA engine.

11. The operating method of claim 10, further comprising:
transmitting, by the file server, a result of file I/O performed in response to the file I/O request to the Linux of the unikernel system.

12. The operating method of claim 10, wherein the extracting the file information from the file system comprises:
extracting the file information, which is necessary in order to execute a file I/O command for a file identified by a file descriptor included in the file I/O request.

13. The operating method of claim 10, further comprising:
dictating, by the file server, that the data input to or output from the nonvolatile memory be copied to an RDMA Network Interface Card (NIC).

14. The operating method of claim 10, wherein the RDMA engine transmits the data to a physical memory of a unikernel of the unikernel system through RDMA.

15. An apparatus for offloading file input/output (I/O) based on Remote Direct Memory Access (RDMA), comprising:
at least one processor; and
a memory configured to store a unikernel and a Linux run by the at least one processor,
wherein an application of the unikernel calls a file I/O kernel function, the file I/O kernel function generates file I/O information, and the file I/O information is transmitted to the Linux, and
the Linux configures and calls a file I/O function using the file I/O information and a file I/O request corresponding to the file I/O information is transmitted from the file I/O function to a file server.

16. The apparatus of claim 15, wherein the Linux receives the file I/O information from the unikernel by running a file I/O proxy.

17. The apparatus of claim 15, wherein the Linux transmits an I/O command to the file server in order to read data having a size corresponding to an I/O vector size from a file identified by a file descriptor and to write the data to a physical address specified in an I/O vector using the file I/O information.

18. The apparatus of claim 17, wherein the Linux receives a result of executing the I/O command from the file server.

19. The apparatus of claim 17, further comprising:
an RDMA Network Interface Card (NIC) configured to input or output data to or from the file server based on RDMA in response to the I/O command.

20. The apparatus of claim 15, wherein the Linux is used as a device driver for a storage device of the file server.
